(19) United States
(12) Patent Application Publication
(10) Pub. No.: US 2013/0177176 A1
(43) Pub. Date: Jul. 11, 2013

(54) SYSTEM FOR WIRELESS SWITCHING AND CONTROLLING OF AUDIO SIGNALS AS RELATED TO MUSICAL AUDIO APPLICATIONS SUCH AS AUDIO EFFECTS, EFFECTS PEDALS, PEDALBOARDS, MIXERS, AND STUDIO EQUIPMENT

(71) Applicant: FXCONNECTX, LLC, Holiday, FL (US)

(72) Inventors: Michael J. Vumbaco, Holiday, FL (US); James Arcidiacono, Holiday, FL (US)

(73) Assignee: FXCONNECTX, LLC, Holiday, FL (US)

(21) Appl. No.: 13/648,265

(22) Filed: Oct. 9, 2012

Related U.S. Application Data
(60) Provisional application No. 61/584,389, filed on Jan. 9, 2012.

(51) Int. Cl. H02B 1/00

(52) U.S. Cl. 381/123

(57) ABSTRACT

A system for wireless control of audio signal switching. The system includes a wireless transmitter having a physically actuated switch, and a main unit. The main unit includes a wireless receiver and one or more relays which may switch the path of the audio signal or provide remote control of external devices, in response to input at the physically actuated switch.

### CROSS-REFERENCE TO RELATED APPLICATION(S)

The present application claims the benefit of Provisional Application No. 61/584,389, filed Jan. 9, 2012, entitled “WIRELESS SWITCH AND CONTROL FOR EFFECT PEDAL, PEDALS, STOMP BOXES AND PEDALBOARDS”, the entire content of which is incorporated herein by reference.

### FIELD

The present invention relates to the switching of audio signals for the purpose of configuring audio effects, and more particularly to a system for controlling such a system by hand-actuated or foot-actuated wireless means.

### BACKGROUND

When performing music using an amplified instrument it is often desirable to modify the audio signal electronically before amplifying the signal and converting it to audible sound. For example, a musician playing an electric guitar may have one or more electronic effects pedals connected in a cascade between the guitar and the amplifier. Such an arrangement may result in long audio cables.

Even greater cable lengths may be needed, for example, if a musician is performing at the front of a stage using an electric guitar connected by wireless audio signal link to a receiver at the back of the stage. In this case it may be necessary to route the audio signal from the receiver to effects pedals at the front of the stage, and back to an amplifier at the back of the stage, using audio cables spanning, in total, twice the depth of the stage. Long audio cables may compromise audio sound quality. Thus, there is a need for a system for connecting effects pedals into an audio signal system which avoids the need for long cables.

### SUMMARY

The present invention relates to wireless control of audio signal switching. In one embodiment, a wireless transmitter transmits control signals to a wireless receiver in a main unit, which, in response, switches an audio signal accordingly. The system for wireless switching and controlling of audio signals may be used for musical audio applications such as audio effects, effects pedalboards, mixers, and studio equipment.

According to an embodiment of the present invention there is provided a system for wireless control of audio signal switching, the system including: a wireless transmitter including a first physically actuated switch, and a main unit; the main unit including a wireless receiver; a first relay coupled to the wireless receiver; an audio input connector; an audio output connector; a first effects connector; and a second effects connector; wherein the wireless transmitter and the wireless receiver are configured to energize or de-energize the first relay in response to actuation of the first physically actuated switch, wherein the main unit is configured to operate in a first audio control state or a second audio control state, and to transition between the first audio control state and the second audio control state in operation, wherein the first relay is energized in one of the first audio control state and the second audio control state and the relay is de-energized in the other of the first audio control state and the second audio control state; wherein when operating in the first audio control state, the main unit is configured to route an audio signal from the audio input connector directly to the audio output connector, and when operating in the second audio control state, the main unit is configured to route an audio signal from the audio input connector to the first effects connector, and to route an audio signal from the second effects connector to the audio output connector.

In one embodiment, the physically actuated switch is a momentary contact switch.

In one embodiment, the main unit is configured to transition from one of the first audio control state and the second audio control state to the other one of the first audio control state and the second audio control state when the physically activated switch is activated after having been deactivated.

In one embodiment, the main unit is configured to operate in one of the first audio control state or the second audio control state when the physically activated switch is activated, and in the other one of the first audio control state or the second audio control state when the physically activated switch is deactivated.

In one embodiment, when the main unit is disconnected from a source of electrical power, the main unit is configured to route an audio signal from the audio input connector directly to the audio output connector.

In one embodiment, the main unit further includes: a switching control connector comprising a conductor; wherein when operating in the first audio control state, the conductor is configured to be disconnected, and when operating in the second audio control state, the conductor is configured to be connected to ground.

In one embodiment, the main unit is configured to transition from one of the first audio control state and the second audio control state to the other one of the first audio control state and the second audio control state when the physically activated switch is activated after having been deactivated.

In one embodiment, the main unit is configured to operate in one of the first audio control state or the second audio control state when the physically actuated switch is activated, and in the other one of first audio control state or the second audio control state when the physically actuated switch is deactivated.

In one embodiment, the wireless transmitter includes a debounce circuit.

In one embodiment, the debounce circuit is configured to introduce a response delay of not more than 20 milliseconds.

In one embodiment, the wireless transmitter and the wireless receiver are connected by a wireless link having a security protocol, wherein the security protocol is configured to prevent signal sources other than the wireless transmitter from affecting the operation of the main unit.

In one embodiment, the security protocol includes a receiver debounce module, the receiver debounce module being configured to introduce a response delay of not more than 20 milliseconds.

In one embodiment, the security protocol includes 4.2 billion codes, wherein the main unit is configured to accept a correct one of the 4.2 billion codes, and wherein only a transmitter transmitting the correct one of the 4.2 billion codes affects the operation of the main unit.

In one embodiment, the system further includes a second relay; a third relay; and a fourth relay.

In one embodiment, the system includes a first display comprising a single circle centered in a square; a second display comprising two circles at diagonally opposite corners of a square; a third display comprising a circle centered in a square and two circles at diagonally opposite corners of a square; and a fourth display comprising four circles at the four corners of a square; wherein the circles in any display are configured to be illuminated or extinguished in accordance with whether the corresponding relay is energized or de-energized.

In one embodiment the system includes: a plurality of relays comprising the first relay; and a plurality of physically actuated switches comprising the physically actuated switch; wherein the main unit is configured to operate in a plurality of audio control states, each audio control state corresponding to one of the momentary contact switches, and each audio control state corresponding to a subset of the relays being energized and the remainder of the relays being de-energized; and wherein the main unit is configured to transition, when one of the physically actuated switches is activated after having been deactivated, to the corresponding audio control state.

In one embodiment, the physically actuated switches are momentary contact switches.

In one embodiment, the main unit further includes a remote control interface, and the system further includes: a remote control sender comprising a second physically actuated switch, and a cable connecting the remote control sender and the remote control interface, wherein the remote control sender and the remote control interface are configured to energize or de-energize the first relay in response to actuation of the second physically actuated switch.

According to an embodiment of the present invention there is provided a system for wireless control of audio signal switching, the system including: a wireless transmitter including a first physically actuated switch, and a main unit; the main unit including a wireless receiver; a first relay coupled to the wireless receiver; an audio input connector; and an audio output connector; wherein the wireless transmitter and the wireless receiver are configured to energize or de-energize the first relay in response to actuation of the first physically actuated switch, wherein the main unit is configured to operate in a first audio control state or a second audio control state, and to transition between the first audio control state and the second audio control state in operation, wherein the first relay is energized in one of the first audio control state and the second audio control state and the relay is de-energized in the other of the first audio control state and the second audio control state; and wherein when operating in the first audio control state, the main unit is configured to route an audio signal from the audio input connector directly to the audio output connector, and when operating in the second audio control state, the main unit is configured to disable the audio output connector.

In one embodiment, the main unit is configured to transition from one of the first audio control state and the second audio control state to the other one of the first audio control state and the second audio control state when the physically activated switch is activated after having been deactivated.

According to an embodiment of the present invention there is provided a system for remote control of audio signal switching, the system including: a remote control sender including a first physically actuated switch; a cable; and a main unit; the main unit including: a remote control interface; and a first relay coupled to the remote control interface; an audio input connector; an audio output connector; a first effects connector; and a second effects connector; wherein the remote control sender and the remote control interface are connected by the cable and configured to energize or de-energize the first relay in response to actuation of the first physically actuated switch wherein the main unit is configured to operate in a first audio control state or a second audio control state, and to transition between the first audio control state and the second audio control state in operation, wherein the first relay is energized in one of the first audio control state and the second audio control state and the relay is de-energized in the other of the first audio control state and the second audio control state; wherein when operating in the first audio control state, the main unit is configured to route an audio signal from the audio input connector directly to the audio output connector, and when operating in the second audio control state, the main unit is configured to route an audio signal from the audio input connector to the first effects connector, and to route an audio signal from the second effects connector to the audio output connector.

### BRIEF DESCRIPTION OF THE DRAWINGS

These and other features and advantages of the present invention will become appreciated as the same become better understood with reference to the specification, claims and appended drawings wherein:

FIG. 1 is a block diagram of a system for wireless switching of audio signals according to an embodiment of the present invention;

FIG. 2A is a block diagram of a system for wireless switching of audio signals, with two audio signal routing blocks in the loop active state, according to an embodiment of the present invention;

FIG. 2B is a block diagram of a system for wireless switching of audio signals, with two audio signal routing blocks in the bypass state, according to an embodiment of the present invention;

FIG. 3 is a block diagram of a system for wireless switching of audio signals according to another embodiment of the present invention;

FIG. 4A is a schematic diagram of an audio signal routing block in the bypass state according to an embodiment of the present invention;

FIG. 4B is a schematic diagram of an audio signal routing block in the loop active state according to an embodiment of the present invention;

FIG. 5A is a schematic diagram of a control block in the open state according to an embodiment of the present invention;

FIG. 5B is a schematic diagram of a control block in the grounded state according to an embodiment of the present invention;

FIG. 6A is a schematic diagram of a mute block in the un-muted state according to an embodiment of the present invention;

FIG. 6B is a schematic diagram of a mute block in the muted state according to an embodiment of the present invention;

FIG. 7 is a diagram of a display panel according to an embodiment of the present invention; and

FIG. 8 is a block diagram of a system for wireless or remote switching of audio signals according to another embodiment of the present invention;

### DETAILED DESCRIPTION

The detailed description set forth below in connection with the appended drawings is intended as a description of exemplary embodiments of a system for wireless switching of audio signals provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

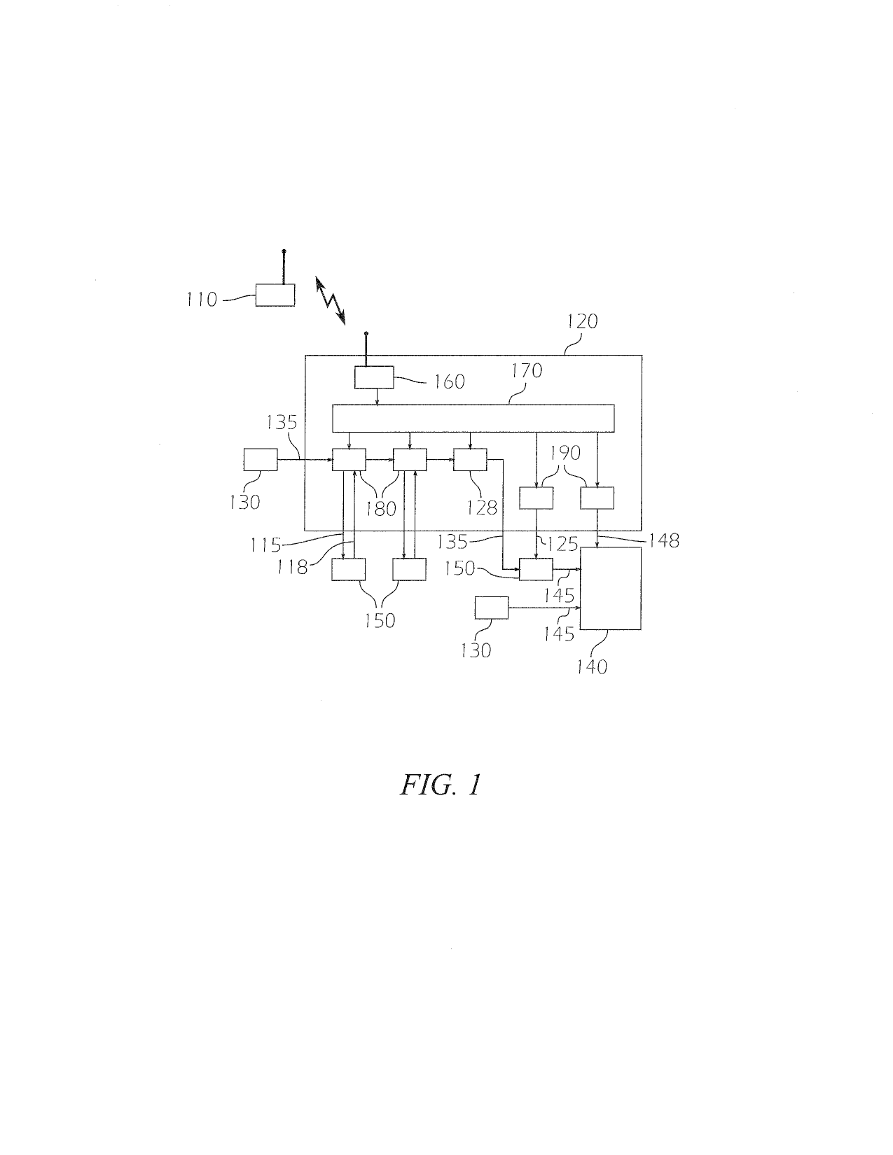

Referring to FIG. 1, in one embodiment a system for wireless switching of audio signals includes a wireless transmitter 110, a main unit 120, one or more audio sources 130, one or more effects pedals 150, and an audio amplifier 140. The main unit 120 may include a wireless receiver 160, a central control unit 170, one or more audio signal routing blocks 180, one or more control blocks 190, and a mute block 128. In operation, the audio signal from an audio source 130 propagates into the main unit audio input 135. Inside the main unit 120, the central control unit 170 controls the states of the audio signal routing blocks 180, controlling the path and processing of the audio signal as it propagates through the main unit 120 to the main unit audio output 138. From the main unit audio output 138, the signal propagates to an effects pedal 150 and to an audio amplifier 140. The audio amplifier 140 may have an electrical output suitable for driving speakers, or it may have built-in speakers so that it may output acoustic power.

The main unit may have an effects send output 115 and a corresponding effects return input 118 for each of the audio signal routing blocks 180. In operation, one or more audio effects pedals 150 may be connected between the effects send output 115 and the corresponding effects return input 118, forming an effects loop. The audio signal routing block 180 is capable of operating in one of two states (audio control states), i.e., a bypass state and a loop active state. When the audio signal routing block 180 is in the bypass state, the audio signal propagates directly from the audio input to the output of the audio signal routing block 180; when the audio signal routing block 180 is in the loop active state, it routes the audio signal out of the effects send output 115 and back in through the corresponding effects return input 118.

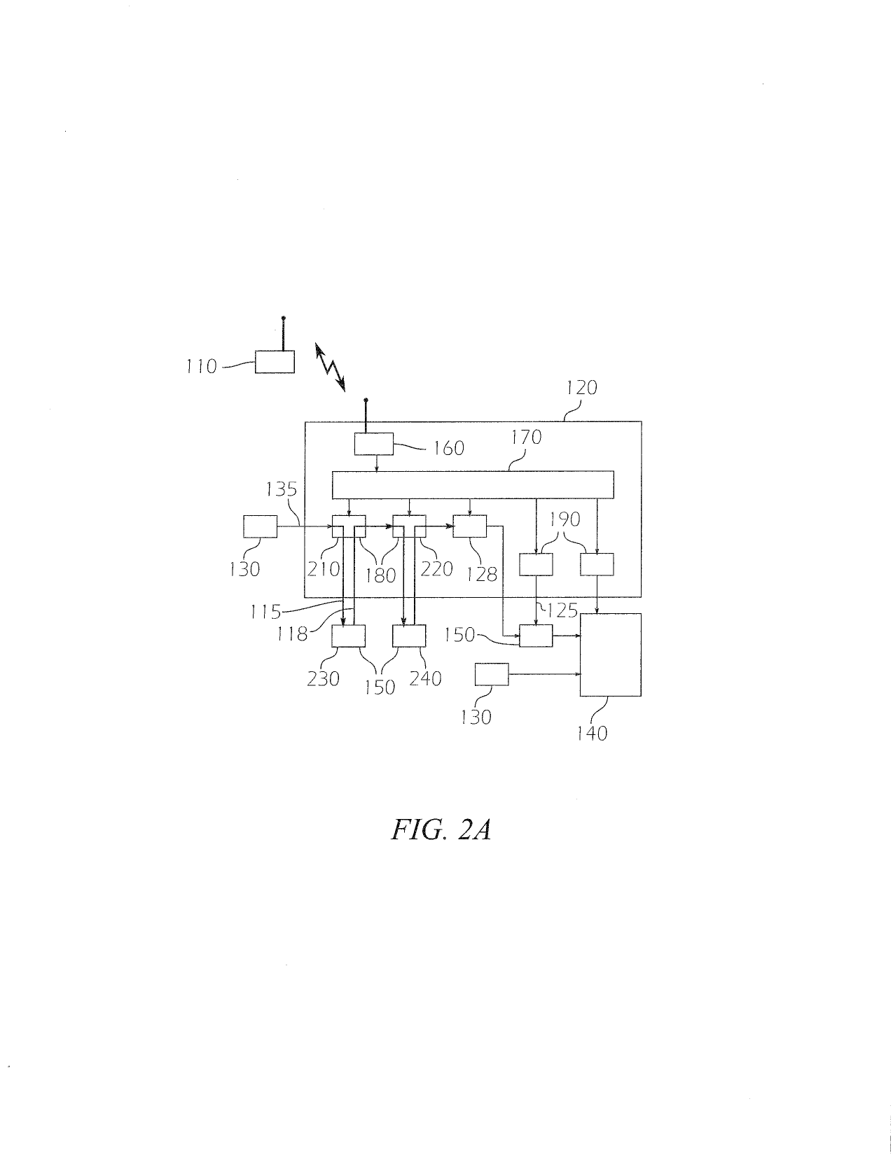

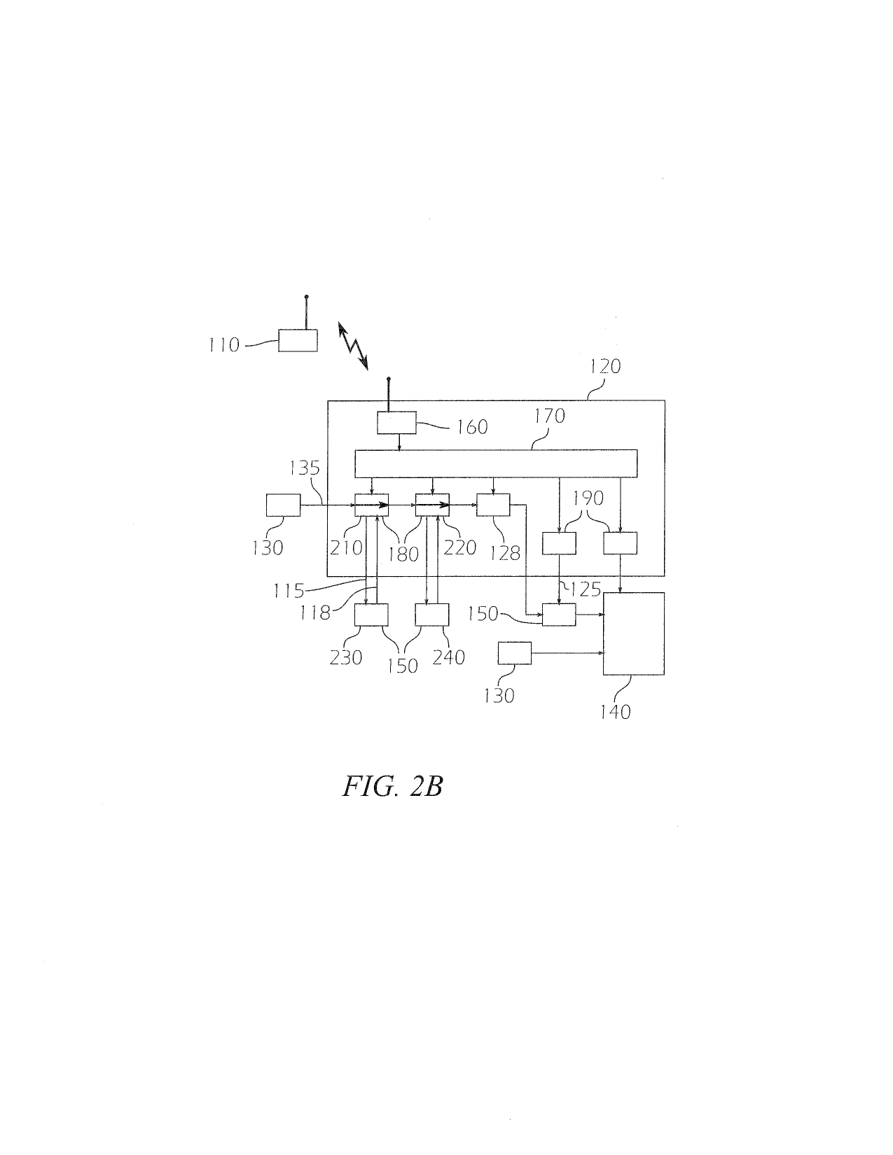

For example, referring to FIG. 2A, in an exemplary embodiment having two audio signal routing blocks 180, the audio signal may travel from the first audio signal source into the main unit audio input 135, and into the audio input of the first audio signal routing block 210. In one state, illustrated in FIG. 2A, in which both audio signal routing blocks 180 are in their respective loop active states, the audio signal may be routed, by the first audio signal routing block 210, through a first effects pedal 230 connected to the first effects send output 115 and the first effects return input 118 respectively. The second audio signal routing block 220 may then route the signal through a second effects pedal 240. In such a state each effects pedal 150 may add an effect, i.e., modify the audio signal passing through it. Commonly available effects pedals 150 may also include foot switches for enabling or disabling the effect. In this case, the musician has two ways of switching a given effect off: either by using the foot switch on the effects pedal 150, or by commanding the main unit 120 not to route the audio signal through the effects pedal 150. The effects pedal 150 will add its effect to the sound only when it has been turned on by its foot switch and when it is switched into the audio path by the corresponding audio signal routing block 180, i.e., when the audio signal routing block 180 is in the loop active state.

Referring to FIG. 2B, in another state both audio signal routing blocks 180 may be in their respective bypass states, as a result of which the audio signal may not be looped through either effects pedal 150, and neither effect will be added to the audio signal.

Referring again to FIG. 1, the main unit 120 may also include one or more control outputs 125 connected to control blocks 190. In one embodiment, the control output 125 may present a high output impedance in a first state and a short to ground in a second state. An effects pedal 150 configured to accept a remote control input may be connected to one of the control outputs 125, and whether it adds the effect may then be controlled through this connection. Similarly, an audio amplifier 140 may have an internal A/B switch configured to be remotely controlled via the amplifier's control input 148. This control input may also be connected to one of the control outputs 125 of the main unit 120, as illustrated in FIG. 1. In this case, the audio amplifier 140 may have two signal inputs 145, and its output may correspond to the first or the second input depending on the setting of the audio amplifier's A/B switch.

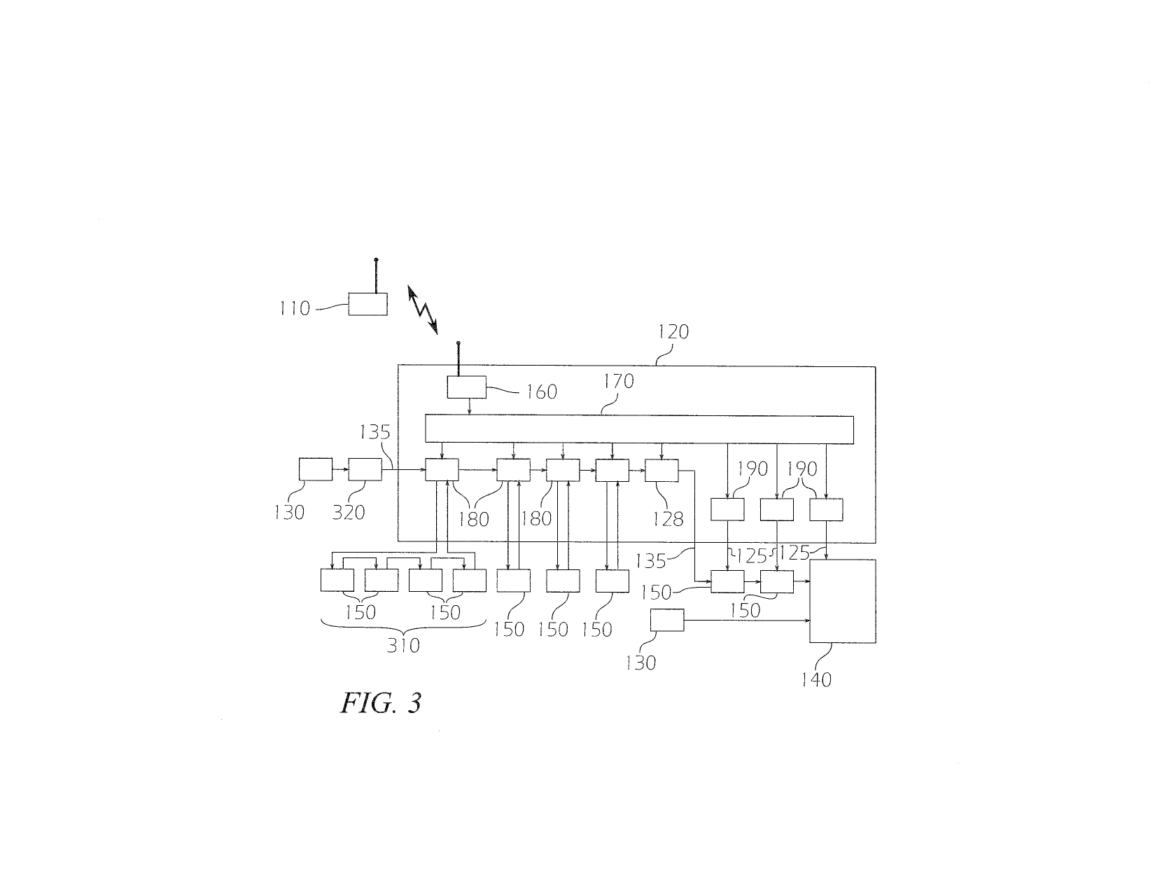

Referring to FIG. 3, multiple suitable variations are possible on both the configuration of the main unit 120 and on its assembly with audio sources 130 and effects pedals 150. For example, there need not be two audio signal routing blocks 180 (as shown in FIG. 1), but there may be more, e.g., four, as illustrated in FIG. 3, or fewer. Similarly there may be more or fewer control blocks 190. Moreover, as shown in FIG. 3, the user may elect to set up grouped effects pedals 310, i.e., effects pedals 150 that are or ganged together. This may be accomplished as shown, for example, by cascading the effects pedals 150 and connecting them to a single effects send output 115 and back to the corresponding effects return input 118, so that when the corresponding audio signal routing block 180 is in the loop active state and routes the audio signal through that effects send output 115 and effects return input 118, all of the grouped effects pedals 310 are simultaneously or concurrently switched into the audio signal path. The user may also set up autonomous effects pedals 320 by installing them before or after the main unit 120, so that their influence on the audio signal is independent of the state of the main unit 120.

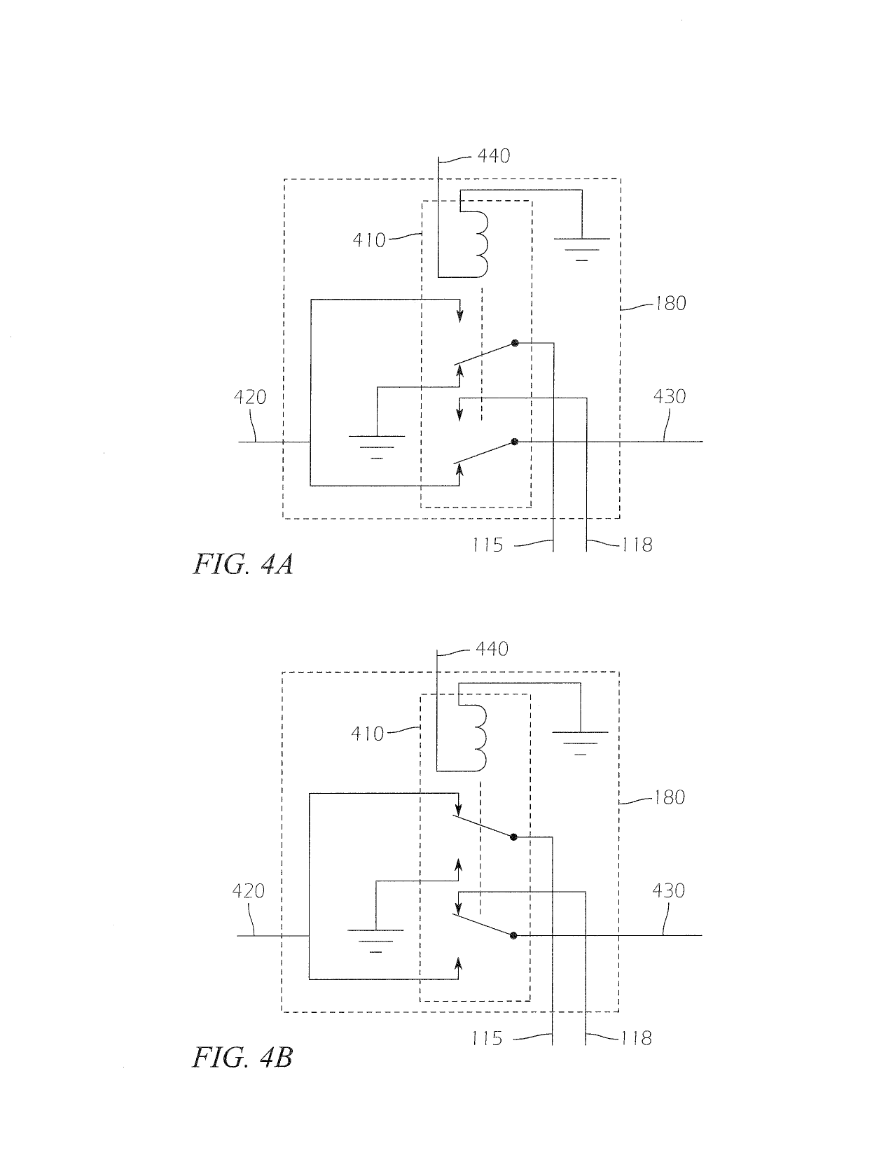

Referring to FIG. 4A, in one embodiment an audio signal routing block 180 may be built using a double-pole double-throw (DPDT) relay 410. When the relay 410 is de-energized, the audio signal routing block 180 may be in the bypass state shown in FIG. 4A, in which the audio signal propagates directly from the audio signal routing block audio input 420 to the audio signal routing block audio output 430. In the loop active state of FIG. 4B, the audio signal is diverted to the effects send output 115 and then returned into the audio signal path from the effects return input 118. Although the embodiment illustrated in FIGS. 4A and 4B represents one way to construct an audio signal routing block 180, the present invention is not limited thereto; the switching functions may also be accomplished using two single-pole double-throw (SPDT) relays, or using four single-pole single-throw (SPST) relays.

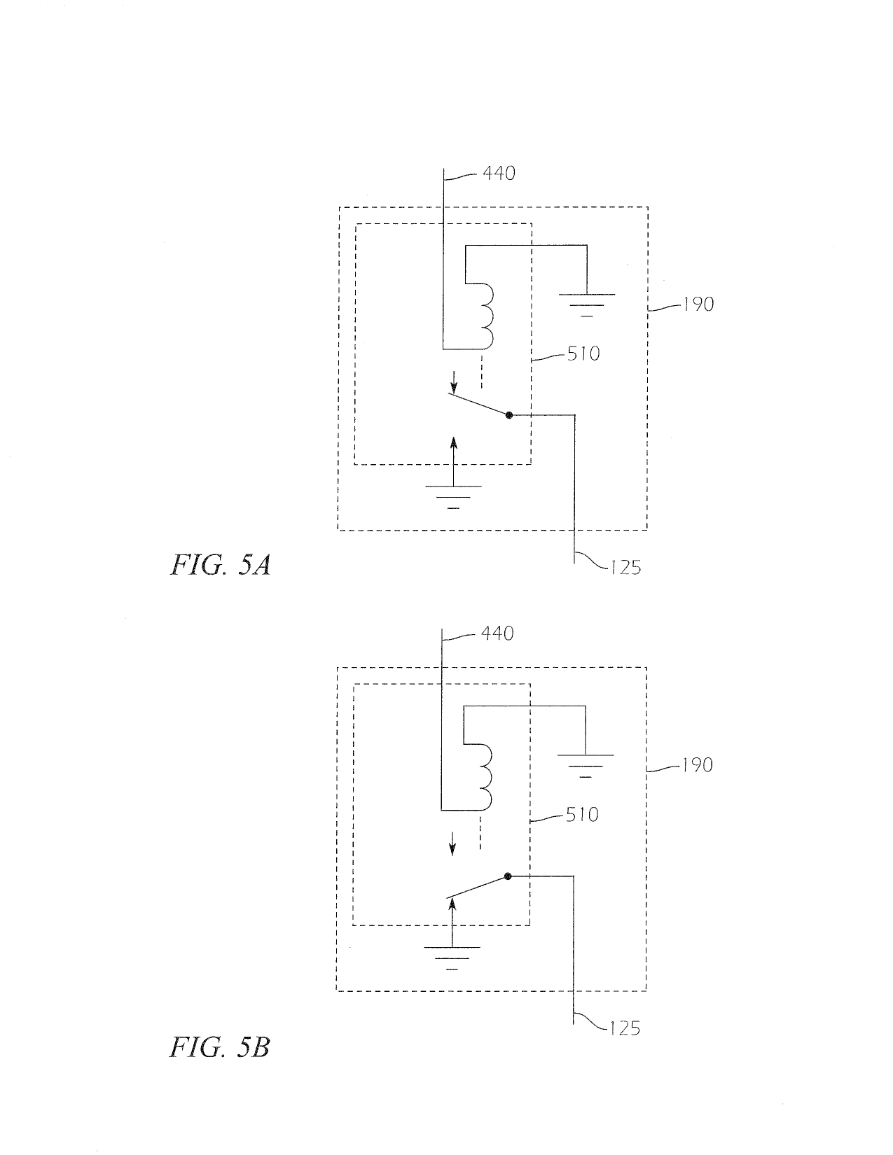

Referring to FIG. 5A, a control block 190 may be implemented using an SPST relay 510 as illustrated. In a first state, illustrated in FIG. 5A, the relay 510 switch is open and the control output 125 is not connected. In a second state, illustrated in FIG. 5B, the relay 510 switch is closed, and control output 125 is connected to ground. The control output 125 may then be used to control external equipment configured to be controlled by such a connection. Such external equipment may for example include equipment with a control input (FIG. 1) composed of a logic input with a pull-up resistor.

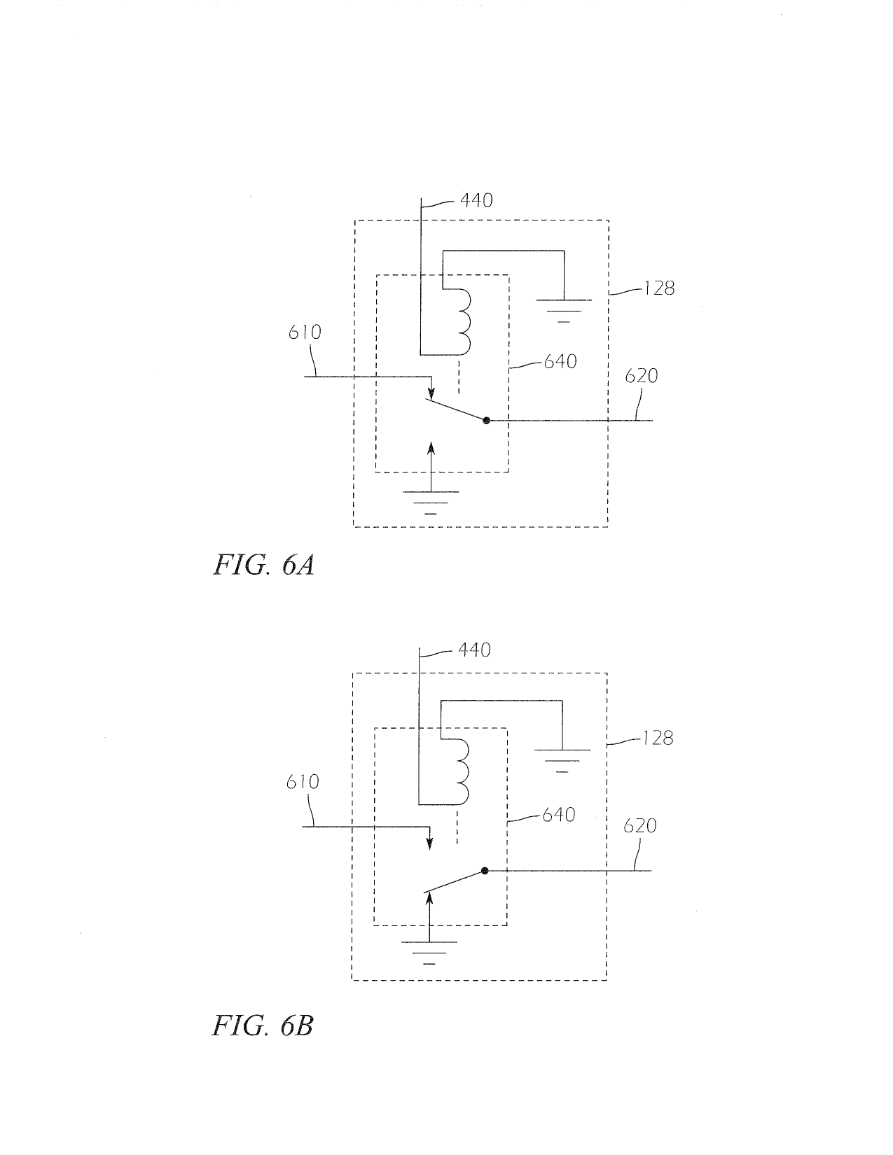

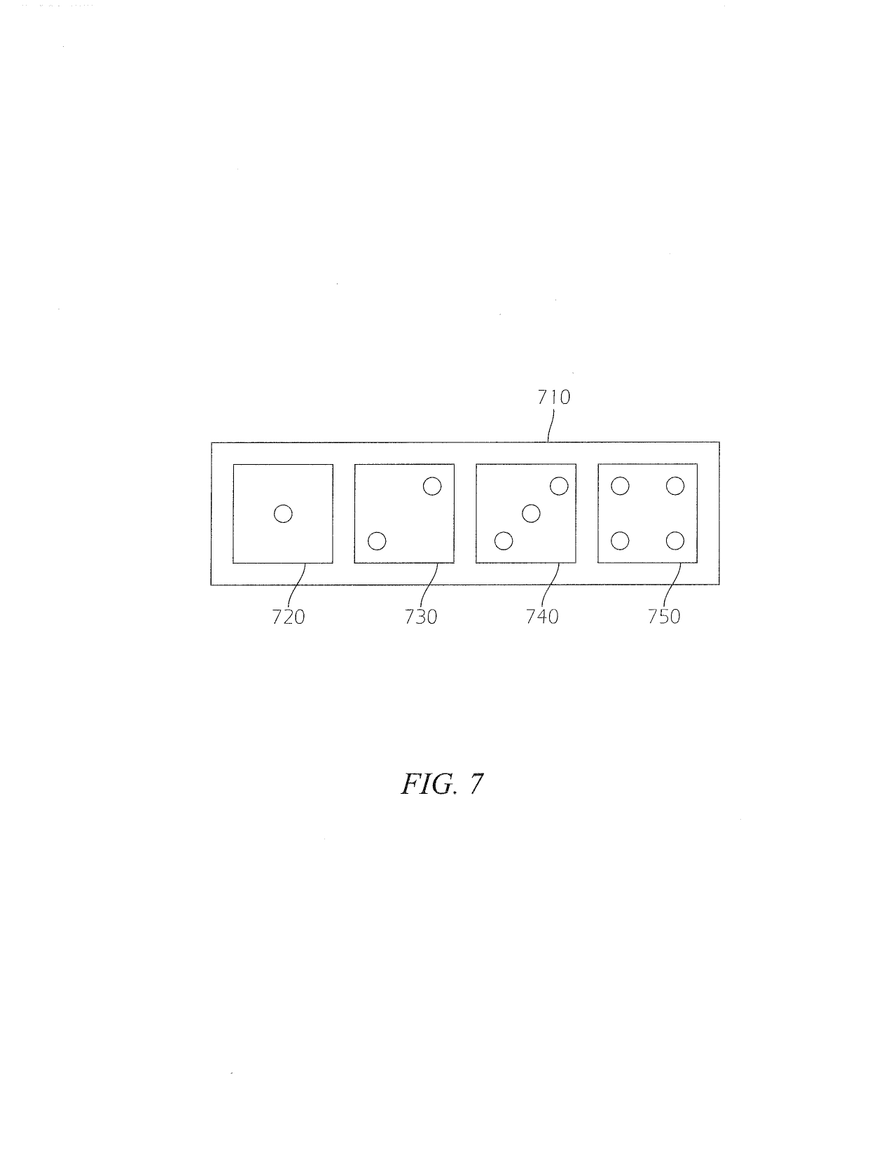

Referring to FIG. 6A, a mute block 128 may be implemented with an SPDT relay 640 which in the un-muted state is shown to route the mute block audio input 610 through to the mute block audio output 620. In the muted state, illustrated in FIG. 6B, the SPDT relay 640 disconnects the mute block audio input 610 and grounds the mute block audio output 620.

In one embodiment, the main unit 120 is configured to be fail-safe, i.e., configured so that if power to the main unit 120 is lost, audio is still transmitted, bypassing any effects connected to the send connectors and return connectors. This may be accomplished by selecting the normally closed positions of the relays to transmit the audio signal through each block. For example, the audio signal routing blocks 180 may be configured so that the bypass mode is the mode for which the relay 410 is de-energized. Moreover, the mute block 128 may be configured so that it is in the un-muted state when the SPDT relay 640 is de-energized.

In one embodiment, the central control unit 170 receives a signal from the wireless receiver 160 whenever a physically actuated switch is activated on the wireless transmitter 110. The physically actuated switch may be any of a variety of types of switches actuated by any human action including without limitation hand actuated switches, foot actuated switches and less common varieties such as a switch worn on the head and actuated by nodding of the head. It may be, for example, a momentary contact switch, a maintained contact switch, an alternate action switch, a pushbutton switch, a toggle switch, a finger-actuated switch or a foot switch, or combinations of the above such as a momentary contact foot switch. The wireless signals sent by the wireless transmitter 110, received by the wireless receiver 160, and relayed to the central control unit 170 may affect the state of the central control unit 170, and, thereby, the state of the main unit 120, in several ways.

In one embodiment, the wireless transmitter 110 may have four momentary contact pushbutton switches corresponding to four effects channels and each switch may operate independently in a mode referred to as toggle mode, in which each time the button for a channel is pressed, the corresponding channel toggles between its two states. For example, channel 1 may correspond to the first audio signal routing block 210 in the main unit 120, and if initially it is in bypass mode, then pressing button 1 on the wireless transmitter 110 will cause the first audio signal routing block 210 to transition to the loop active state. When the first audio signal routing block 210 is in the loop active state, pressing button 1 on the wireless transmitter 110 will cause the first audio signal routing block 210 to transition to the bypass state.

In one embodiment, the main unit 120 may be configured so that the channels operate in a mode referred to as latch mode, in which turning on any one channel, e.g., setting it to the loop active state, turns off the remaining channels, e.g., sets each of them to the bypass state. In another embodiment, one or more channels may be configured to operate in a momentary mode, in which the channel is on, i.e., in its loop active state, only while the corresponding switch on the wireless transmitter 110 is activated.

These configuration options may be combined in various suitable ways. For example, three channels may be configured to be operating together in latch mode, while a fourth channel is in toggle mode, and a fifth in momentary mode. Each of these channels may correspond to an audio signal routing block 180, a control block 190, or a mute block 128.

The central control unit 170 may include one or more processors executing computer program instructions and interacting with other system components for performing the various suitable functionalities described herein. The computer program instructions are stored in a memory implemented using a standard memory device, such as, for example, a random access memory (RAM). The computer program instructions may also be stored in other non-transitory computer readable media such as, for example, a CD-ROM, flash drive, or the like.

In one embodiment, the main unit 120 may include a display panel 710 with up to six patterns corresponding to the six faces of a die. For example, a display 720 corresponding to channel 1 may show a single circle at the center of a square, a display 730 corresponding to channel 2 may show two circles at diagonally opposite corners of a square, a display 740 corresponding to channel 3 may show a circle centered in a square and two circles at diagonally opposite corners of a square, and a display 750 corresponding to channel 4 may show four circles at the four corners of a square. Each of these displays may be illuminated when the corresponding channel is on, e.g., in the loop active state.

The system may include provisions for debouncing the physically actuated switches in the wireless transmitter 110. Such switches may, especially when transitioning from the a non-conducting state to a conducting state, transition multiple times between conducting current and not conducting current in a short time, as the mechanical contacts bounce against each other and then come to rest. Especially when the effect of making and breaking the connection is to toggle the state of part of the system, switch bounce is undesirable as the random number of bounces may result in an unpredictable final state. Debouncing methods include implementing, in software or hardware, provision for ignoring changes in the switch until it has been in a new state for some interval, which may be referred to as the debounce delay.

A provision for debouncing, which may be referred to as a debounce circuit, may be implemented in the wireless transmitter 110. In one embodiment, the debounce delay may be chosen to be long enough to reliably prevent switch bounce from triggering undesirable state transitions while also being short enough to avoid undesirable response delays. In one embodiment, the debounce delay may be 20 milliseconds (ms).

Coding methods may be used to avoid interference from other sources of electromagnetic energy transmitting at the same or nearby frequencies. Such other sources may include broadband sources such as machinery or even lightning, or narrowband sources such as other wireless transmitters 110 employed in other applications or a wireless transmitter 110 constructed according to an embodiment of the present invention, operated by another user nearby. To avoid such interference, the signal transmitted may be associated in the wireless transmitter 110 with a code, such as a binary code with a large number of bits, and the wireless receiver 160 may be configured to accept only wireless signals containing the correct code. In one embodiment, measures may be taken during fabrication to ensure that each wireless receiver 160 is assigned a unique code not previously assigned to another wireless receiver 160. In one embodiment, the code may have sufficient length to provide 4.2 billion possible unique codes.

Debouncing measures may also be employed in the wireless receiver 160, where a debounce delay, during which the wireless receiver 160 monitors the received signal to verify that it consistently contains the correct code, may be used to prevent or protect from undesired state transitions that otherwise could be caused by interfering signals. In such an embodiment, the delay may be referred to as a debounce delay because, although it does not primarily mitigate the effects of physical switch bounce, it aids in preventing or protecting from undesired state transitions. As used herein, the term debounce circuit refers to any provision for providing debounce, whether implemented in hardware or in software or in a combination of hardware and software. In one embodiment, the debounce delay in the receiver is 20 ms.

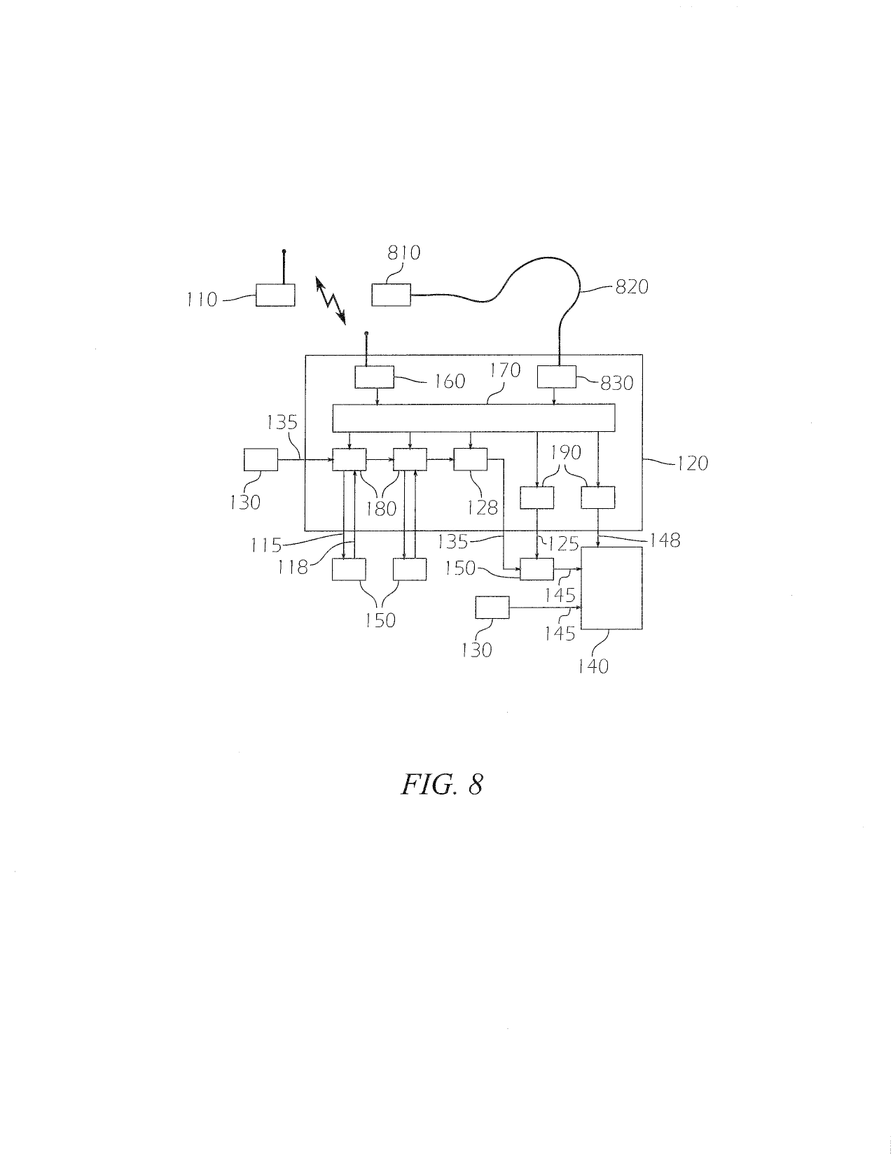

Referring to FIG. 8, a wired control link may in one embodiment be provided to serve as a backup in the event of a fault in the wireless link. This wired control link may comprise a remote control sender 810 comprising a physically actuated switch, which may be any of a variety of types of switches actuated by any human action, including without limitation a hand-actuated or foot-actuated switch. The remote control sender 810 may be connected by a cable 820 to a remote control interface 830 in the main unit. The remote control sender 810 may communicate with the remote control interface 830 using a suitable wired communications protocol. The central control unit in the main unit may energize or de-energize relays in response to actuation of the physically actuated switch on the remote control sender 810 in the same manner as it would in response to actuation of a corresponding switch on the wireless transmitter. The cable 820 and the wired communications protocol connecting the remote control sender 810 and the remote control interface 830 may operate according to any suitable standard, including without limitation Musical Instrument Digital Interface (MIDI), or Universal Serial Bus (USB), or according to a purpose-designed or otherwise non-standard protocol. In another embodiment the wired control link provided by the remote control sender 810, the cable 820, and the remote control interface 830 may the primary means for the user to control the main unit, and the wireless link provided by the wireless transmitter 110 and the wireless receiver 160 may be secondary, or even absent entirely.

Although limited embodiments of the system for wireless switching of audio signals have been specifically described and illustrated herein, many modifications and variations will be apparent to those skilled in the art. Accordingly, it is to be understood that the system for wireless switching of audio signals constructed according to principles of this invention may be embodied other than as specifically described herein. The invention is also defined in the following claims, and equivalents thereof.

What is claimed is:

1. A system for wireless control of audio signal switching, the system comprising:
a wireless transmitter comprising a first physically actuated switch, and a main unit;
the main unit comprising
a wireless receiver;
a first relay coupled to the wireless receiver;
an audio input connector;
an audio output connector;
a first effects connector; and
a second effects connector;
wherein the wireless transmitter and the wireless receiver are configured to energize or de-energize the first relay in response to actuation of the first physically actuated switch,
wherein the main unit is configured to operate in a first audio control state or a second audio control state, and to transition between the first audio control state and the second audio control state in operation,
wherein the first relay is energized in one of the first audio control state and the second audio control state and the relay is de-energized in the other of the first audio control state and the second audio control state;
wherein
when operating in the first audio control state, the main unit is configured to route an audio signal from the audio input connector directly to the audio output connector, and
when operating in the second audio control state, the main unit is configured to route an audio signal from the audio input connector to the first effects connector, and to route an audio signal from the second effects connector to the audio output connector.

2. The system of claim 1 wherein the first physically actuated switch is a momentary contact switch.

3. The system of claim 1, wherein the main unit is configured to transition from one of the first audio control state and the second audio control state to the other one of the first audio control state and the second audio control state when the physically activated switch is activated after having been deactivated.

4. The system of claim 1, wherein the main unit is configured to operate in one of the first audio control state or the second audio control state when the physically activated switch is activated, and in the other one of the first audio control state or the second audio control state when the physically activated switch is deactivated.

5. The system of claim 1, wherein when the main unit is disconnected from a source of electrical power, the main unit is configured to route an audio signal from the audio input connector directly to the audio output connector.

6. The system of claim 1, wherein the main unit further comprises:
a switching control connector comprising a conductor;
wherein
when operating in the first audio control state, the conductor is configured to be disconnected, and
when operating in the second audio control state, the conductor is configured to be connected to ground.

7. The system of claim 6, wherein the main unit is configured to transition from one of the first audio control state and the second audio control state to the other one of the first audio control state and the second audio control state when the physically activated switch is activated after having been deactivated.

8. The system of claim 6, wherein the main unit is configured to operate in one of the first audio control state or the second audio control state when the first physically actuated switch is activated, and in the other one of first audio control state or the second audio control state when the first physically actuated switch is deactivated.

9. The system of claim 1, wherein the wireless transmitter comprises a debounce circuit.

10. The system of claim 9, wherein the debounce circuit is configured to introduce a response delay of not more than 20 milliseconds.

11. The system of claim 1, wherein the wireless transmitter and the wireless receiver are connected by a wireless link having a security protocol, wherein the security protocol is configured to prevent signal sources other than the wireless transmitter from affecting the operation of the main unit.

12. The system of claim 11 wherein the security protocol comprises a receiver debounce module, wherein the receiver debounce module is configured to introduce a response delay of not more than 20 milliseconds.

13. The system of claim 11, wherein the security protocol comprises 4.2 billion codes, wherein the main unit is configured to accept a correct one of the 4.2 billion codes, and wherein only a transmitter transmitting the correct one of the 4.2 billion codes affects the operation of the main unit.

14. The system of claim 1, further comprising
a second relay;
a third relay; and
a fourth relay.

15. The system of claim 14, further comprising
a first display comprising a single circle centered in a square;
a second display comprising two circles at diagonally opposite corners of a square;
a third display comprising a circle centered in a square and two circles at diagonally opposite corners of a square; and
a fourth display comprising four circles at the four corners of a square;
wherein the circles in any display are configured to be illuminated or extinguished in accordance with whether the corresponding relay is energized or de-energized.

16. The system of claim 1, comprising:
a plurality of relays comprising the first relay; and
a plurality of physically actuated switches comprising the first physically actuated switch;
wherein the main unit is configured to operate in a plurality of audio control states comprising the first audio control state and the second audio control state,
each audio control state corresponding to one of the momentary contact switches, and
each audio control state corresponding to a subset of the relays being energized and the remainder of the relays being de-energized; and
wherein the main unit is configured to transition, when one of the physically actuated switches is activated after having been deactivated, to the corresponding audio control state.

17. The system of claim 16, wherein the physically actuated switches are momentary contact switches.

18. The system of claim 1, wherein the main unit further comprises a remote control interface, the system further comprising:
a remote control sender comprising a second physically actuated switch, and
a cable connecting the remote control sender and the remote control interface,
wherein the remote control sender and the remote control interface are configured to energize or de-energize the first relay in response to actuation of the second physically actuated switch.

19. A system for wireless control of audio signal switching, the system comprising:
a wireless transmitter comprising a first physically actuated switch, and a main unit;
the main unit comprising
a wireless receiver;
a first relay coupled to the wireless receiver;
an audio input connector; and
an audio output connector;
wherein the wireless transmitter and the wireless receiver are configured to energize or de-energize the first relay in response to actuation of the first physically actuated switch,
wherein the main unit is configured to operate in a first audio control state or a second audio control state, and to transition between the first audio control state and the second audio control state in operation,
wherein the first relay is energized in one of the first audio control state and the second audio control state and the relay is de-energized in the other of the first audio control state and the second audio control state; and
wherein
when operating in the first audio control state, the main unit is configured to route an audio signal from the audio input connector directly to the audio output connector, and
when operating in the second audio control state, the main unit is configured to disable the audio output connector.

20. The system of claim 19, wherein the main unit is configured to transition from one of the first audio control state and the second audio control state to the other one of the first audio control state and the second audio control state when the physically activated switch is activated after having been deactivated.

21. A system for remote control of audio signal switching, the system comprising:
a remote control sender comprising a first physically actuated switch;
a cable; and
a main unit;
the main unit comprising:
a remote control interface; and
a first relay coupled to the remote control interface;
an audio input connector;
an audio output connector;
a first effects connector; and
a second effects connector;
wherein the remote control sender and the remote control interface are connected by the cable and configured to energize or de-energize the first relay in response to actuation of the first physically actuated switch
wherein the main unit is configured to operate in a first audio control state or a second audio control state, and to transition between the first audio control state and the second audio control state in operation,
wherein the first relay is energized in one of the first audio control state and the second audio control state and the relay is de-energized in the other of the first audio control state and the second audio control state;
wherein
when operating in the first audio control state, the main unit is configured to route an audio signal from the audio input connector directly to the audio output connector, and
when operating in the second audio control state, the main unit is configured to route an audio signal from the audio input connector to the first effects connector, and to route an audio signal from the second effects connector to the audio output connector.
